(19) United States
(12) Patent Application Publication
(10) Pub. No.: US 2008/0041708 A1
(43) Pub. Date: Feb. 21, 2008

(54) Dual mode switch

(75) Inventor: Stephen James, Highland Park, CA (US)

Correspondence Address: Michael Zarrabian, Esq.;Myers Dawes Andras & Sherman, LLP, 19900 MacArthur Blvd., 11th Floor, Irvine, CA, 92612, US

(73) Assignee: Judco Manufacturing, Inc., Harbor City, CA (US)

(21) Appl. No.: 11/729,481

(22) Filed: Mar. 29, 2007

Related U.S. Application Data
(60) Provisional application No. 60/819,516, filed on Jul. 7, 2006.

(51) Int. Cl. H01H 23/30

(52) U.S. Cl. 200/5 R; 200/5 A

(57) ABSTRACT

A switching apparatus has a normally-open switching device comprising first and second normally-open switches and a normally-closed switching device comprising first and second normally-closed switches. The switching apparatus also has an actuator operable in conjunction with the switching devices such that: (a) in a neutral actuator mode the first and second normally-open switches remain open, and the first and second normally-closed switches remain closed, (b) in a first operation mode the actuator operates on the first normally-closed switch and the first normally-open switch, and (c) in a second operation mode the actuator operates on the second normally-closed switch and the second normally-open switch.

### RELATED APPLICATION

This application claims the benefit under 35 U.S.C. 119(e) of U.S. Provisional Patent Application Ser. No. 60/819,516, filed on Jul. 7, 2006, incorporated herein by reference.

### FIELD OF THE INVENTION

The present invention relates to electrical switches, and in particular to dual mode electrical switches.

### BACKGROUND OF THE INVENTION

Many switches that are operable for making and breaking electrical circuits are known. Such switches are operated by a user to break/make electrical contacts for turning on or turning off electrical module(s) connected to the switches. One example includes switches for electrical heating and cooling in vehicles. However, there is a need for a dual mode switch that includes both normally-open and normally-closed contacts which can be used to operate electrical devices in a vehicle such as for heating and cooling a cup holder.

### BRIEF SUMMARY OF THE INVENTION

A switching apparatus has a normally-open switching device comprising first and second normally-open switches and a normally-closed switching device comprising first and second normally-closed switches. The switching apparatus also has an actuator operable in conjunction with the switching devices such that: (a) in a neutral actuator mode the first and second normally-open switches remain open, and the first and second normally-closed switches remain closed, (b) in a first operation mode the actuator operates on the first normally-closed switch and the first normally-open switch, and (c) in a second operation mode the actuator operates on the second normally-closed switch and the second normally-open switch.

These and other features, aspects and advantages of the present invention will become understood with reference to the following description, appended claims and accompanying figures.

### BRIEF DESCRIPTION OF THE DRAWINGS

FIG. 1 shows a perspective view of a switching apparatus with its cover in place, according to an embodiment of the present invention.

FIG. 2 shows a perspective view of the switching apparatus of FIG. 1 with the cover removed.

FIG. 3 shows another perspective view of the switching apparatus of FIG. 1 with the cover removed.

FIG. 4 shows a perspective view of the switching apparatus of FIG. 1 with the cover and bezel removed.

FIG. 5 shows a perspective view of the switching apparatus of FIG. 1 with the cover and bezel removed.

FIG. 6 shows another perspective view of the switching apparatus of FIG. 1 with the cover, bezel and rocker removed.

FIG. 7 shows a perspective view of a switching apparatus with partially pivoted rocker, according to an embodiment of the present invention.

FIG. 8 shows another perspective view of the switching apparatus of FIG. 7.

FIG. 9 shows a side view of the switching apparatus of FIG. 7.

FIG. 10 shows an end view of the switching apparatus of FIG. 7.

FIG. 11 shows a perspective view of a switching apparatus with fully pivoted rocker, according to an embodiment of the present invention.

FIG. 12 shows another perspective view of the switching apparatus of FIG. 11.

FIG. 13 shows a side view of the switching apparatus of FIG. 12.

FIG. 14 shows an end view of the switching apparatus of FIG. 13.

FIG. 15 shows a perspective view of a switching apparatus with un-pivoted rocker, according to an embodiment of the present invention.

FIG. 16 shows another perspective view of the switching apparatus of FIG. 15.

FIG. 17 shows a side view of the switching apparatus of FIG. 15.

FIG. 18 shows an end view of the switching apparatus of FIG. 15.

FIG. 19 shows a perspective view of the top surface of the keypad of the switching device of FIG. 7.

FIG. 20 shows a perspective view of the bottom surface of the keypad of the switching device of FIG. 7.

FIG. 21 shows a perspective view of the bottom surface of the circuit board of the switching apparatus of FIG. 15.

FIG. 22 shows another perspective view of the bottom surface of the circuit board of the switching apparatus of FIG. 15.

FIG. 23 shows another perspective view of the bottom surface of the circuit board of the switching apparatus of FIG. 15.

FIG. 24 shows a perspective view of the top surface of the circuit board of the switching apparatus of FIG. 15.

FIG. 25 shows another perspective view of the top surface of the circuit board of the switching apparatus of FIG. 15.

### DETAILED DESCRIPTION OF THE INVENTION

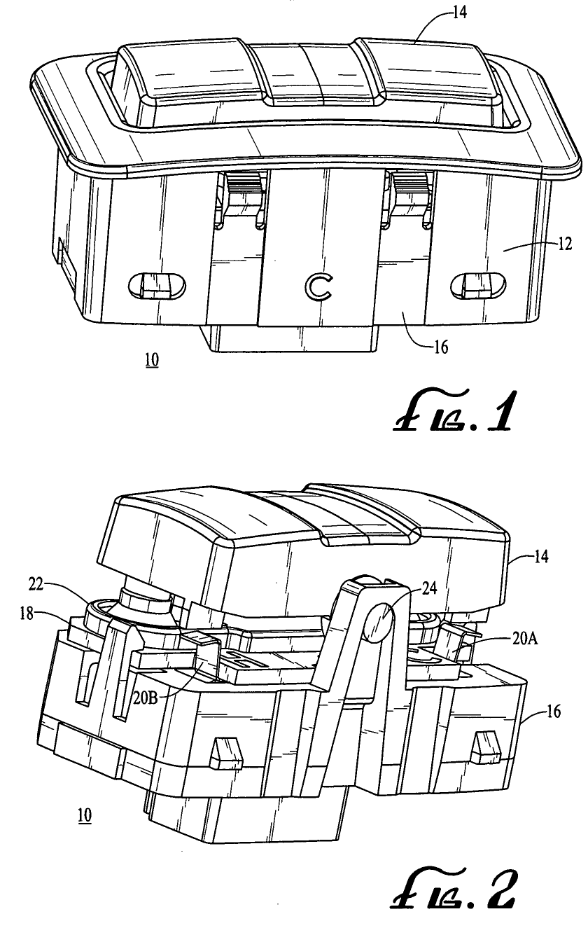

In one embodiment the present invention provides a dual mode switch that in one example application can be used to operate electrical devices in a vehicle. The dual mode switch provides both normally-open and normally-closed positions. Referring to the example embodiment shown in FIGS. 1-4, the dual switch 10 includes a cover 12, and a bezel 16 (although in the following description the element 12 is called a “cover” and the element 16 is called a “bezel”, the terms cover and bezel for the elements 12 and 16, respectively, can be interchanged such that the element 12 is called the bezel 12 and the element 16 is called the cover 16). The switch 10 further includes an actuator comprising a rocker 14, a circuit board (PCB) 18, a normally-closed switching device comprising an elongated contact strip 20, and a normally-open switching device comprising a keypad 22. FIG. 1 shows the switch 10 with the cover 12.

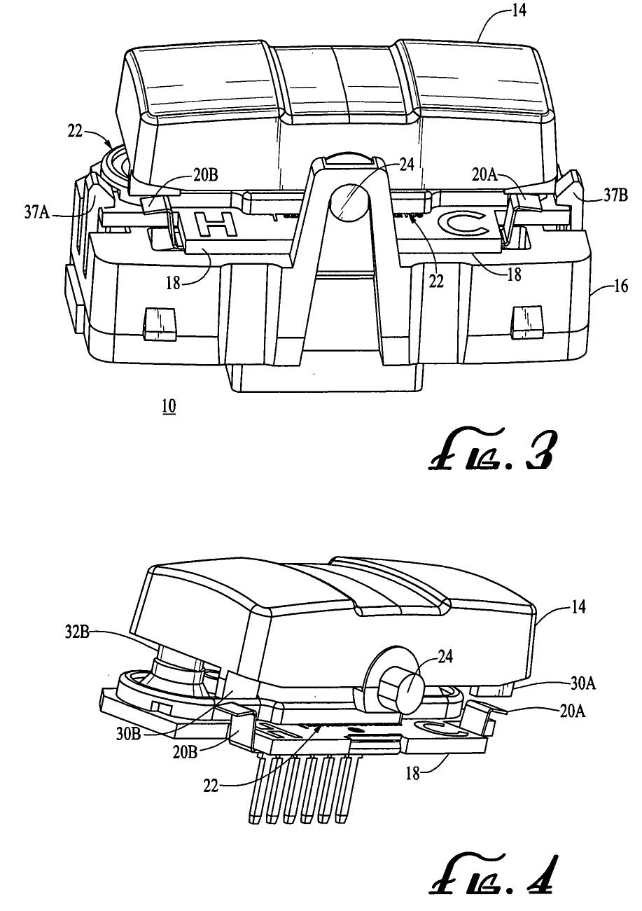

FIGS. 2 and 3 show perspective views of the switch 10 with the cover 12 removed, illustrating that the bezel 16 supports the cover 12, and that the bezel 16 also supports the rocker 14 on hinges 24 on either side, such that the rocker 14 pivots on the hinges 24. The bezel 16 further supports the PCB 18. The PCB 18 is a dual-sided circuit board with conductive traces on opposing surfaces/sides.

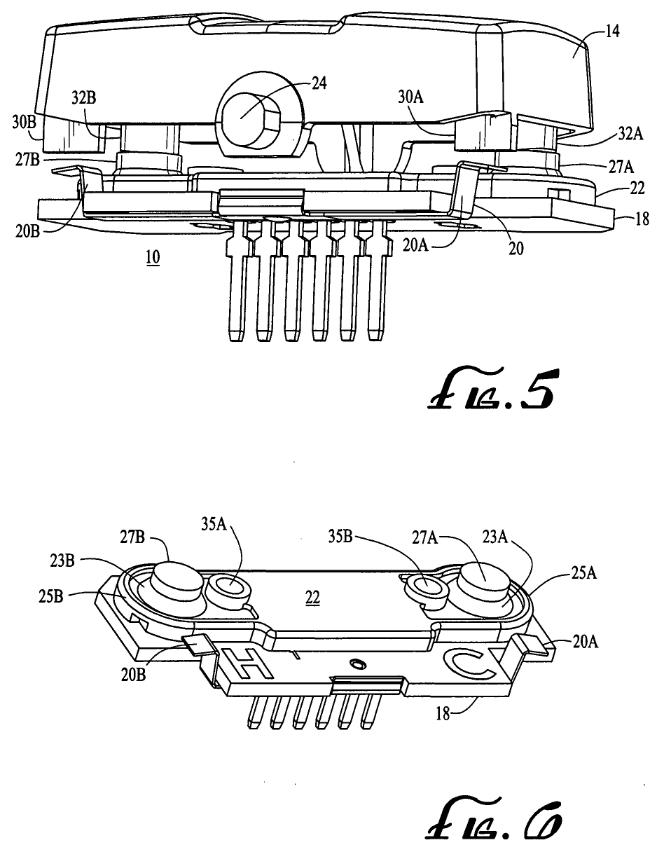

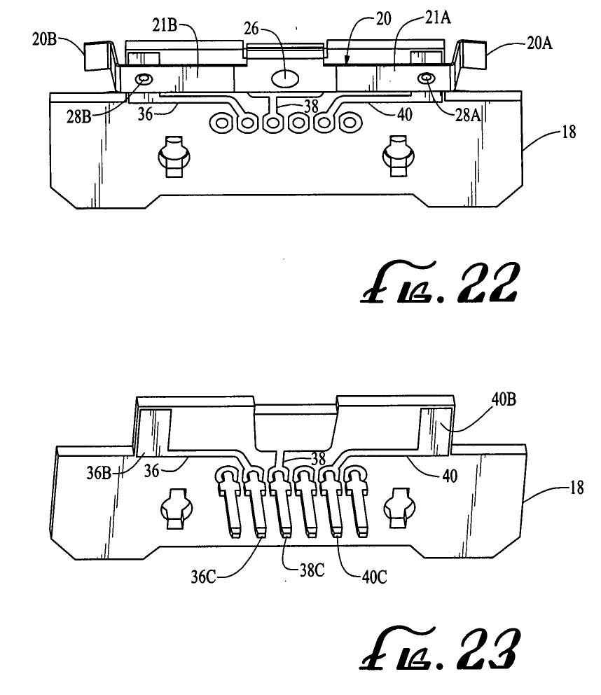

FIG. 4 shows another perspective view of the switching apparatus of FIG. 1 with the cover 12 and bezel 16 removed. FIG. 5 shows the bezel 16 removed, further illustrating that the top surface of the PCB 18 supports the keypad 22, and that the elongated contact 20 is mechanically connected to the bottom surface of the PCB 18 at the center 26 (FIG. 21) of the contact 20.

FIG. 6 shows the rocker 14 removed, illustrating that the elongate keypad 22 is supported by the top surface of the PCB 18, whereby the PCB 18 is sandwiched between the keypad 22 and the contact 20. The contact strip 20 (FIGS. 21-22) has a generally springy characteristic, and as noted, is connected at its center 26 (between the two L-shaped ends 20A, 20B), to the bottom surface of the PCB 18. As such, the springy nature of the contact 20 causes at least protrusions 28A, 28B of the contact 20, on either side of center 26, to be normally urged against, and in contact with, the bottom surface of the PCB 18.

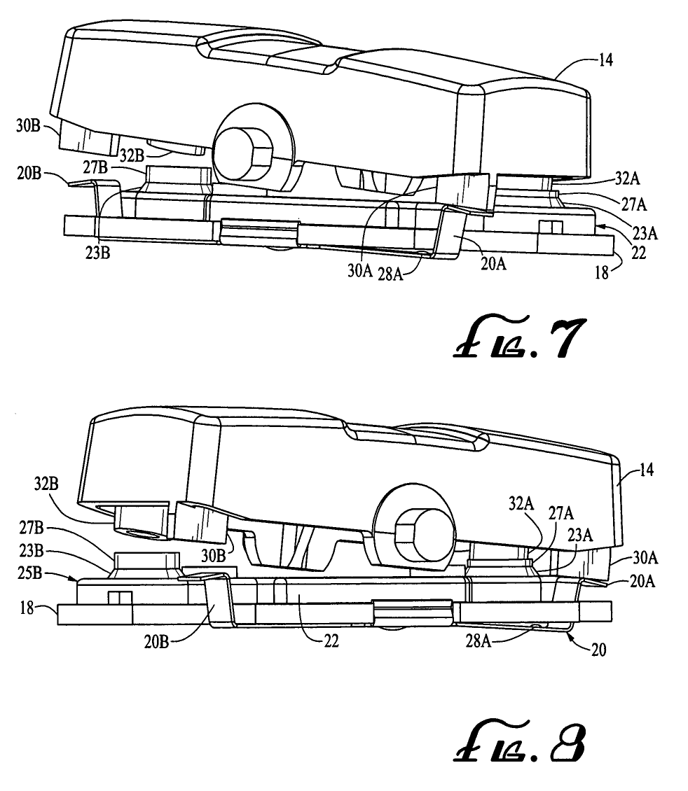

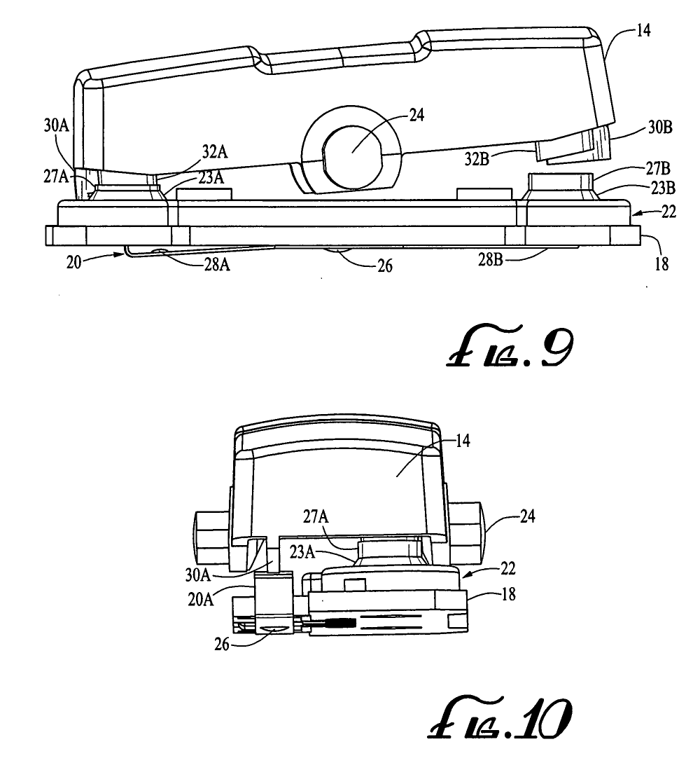

FIGS. 7 and 8 show perspective views of the switch 10 wherein the rocker 14 is partially pivoted to one side on the hinge 24 such that a rocker protrusion (rib) 30A presses against an L-shaped end 20A of the contact 20. FIG. 9 shows a side view of the switch 10 of FIGS. 7-8, and FIG. 10 shows an end view of the switch 10 in FIGS. 7 and 8.

As shown in FIGS. 7-10, when the rocker 14 is partially pivoted on the hinge 24 to one side, such that a rocker protrusion 30A presses against an L-shaped end 20A of the contact 20, the protrusion 28A of contact 20 proximate that L-shaped end 20A is pushed away, and separated from, the bottom surface of the PCB 18. Said protrusion 28A of the contact 20 remains separated from the PCB 18 so long as the rocker protrusion 30A pushes against that L-shaped end 20A of the contact 20. A corresponding rocker protrusion (rib) 30B is moved away from the L-shaped end 20B of the contact 20.

FIG. 6 further shows that at its distal ends, the elongate keypad 22 includes retainer 25A, 25B for domes 23A, 23B having tops 27A, 27B, respectively. Apertures 29A and 29B on the keypad 22 (FIG. 20) and holes 33A, 33B on the PCB 18 (FIG. 21), respectively, are essentially aligned when the keypad 22 is placed on the PCB 18 (FIG. 6) such that posts 35A, 35B (FIG. 6) from the bezel 16 pass through the holes 33A, 33B of the PCB 18 and the apertures 29A and 29B of the keypad 22, respectively, to retain the PCB 18 and the keypad 22 on the bezel 16. Hooks 37A, 37B (FIG. 3) snap over the edges of the PCB 18 and hold it on the bezel 16. The keypad 22 keeps the rocker 14 stabilized when the rocker is not pivoted. The keypad 22, and in particular the domes 23A, 23B, are flexible. Each dome 23A, 23B is compressible, such that, as shown in FIGS. 8-9, when the rocker 14 is partially pivoted to one side, another rocker protrusion (plunger) 32A presses against a top 27A (FIG. 5) of the keypad 22, thereby partially compressing (collapsing) the top 27A into the dome 23A. As such, in FIGS. 8-9, the partially compressed top 27A is partially visible compared to the uncompressed top 27B. A corresponding rocker protrusion (plunger) 32B is moved further away from the top 27B.

As such, when the rocker 14 is not pivoted (e.g., FIGS. 1-4), neither the top 27A, 27B is compressed into corresponding domes 23A, 23B, of the keypad 22. Further, the protrusions 28A, 28B of contact 20 (on either side of the center 26) remain urged against the bottom surface of the PCB 18. When the rocker 14 is partially pivoted to one side (e.g., FIGS. 8-9), the top 27A of the keypad 22 is partially pushed down, partially compressing the corresponding dome 23A. Further, the protrusion 28A of the contact 20 is pushed away (separated) from the bottom surface of the PCB 18 via the compressing action of rocker protrusion 30A on the L-shaped end 20A of the contact 20.

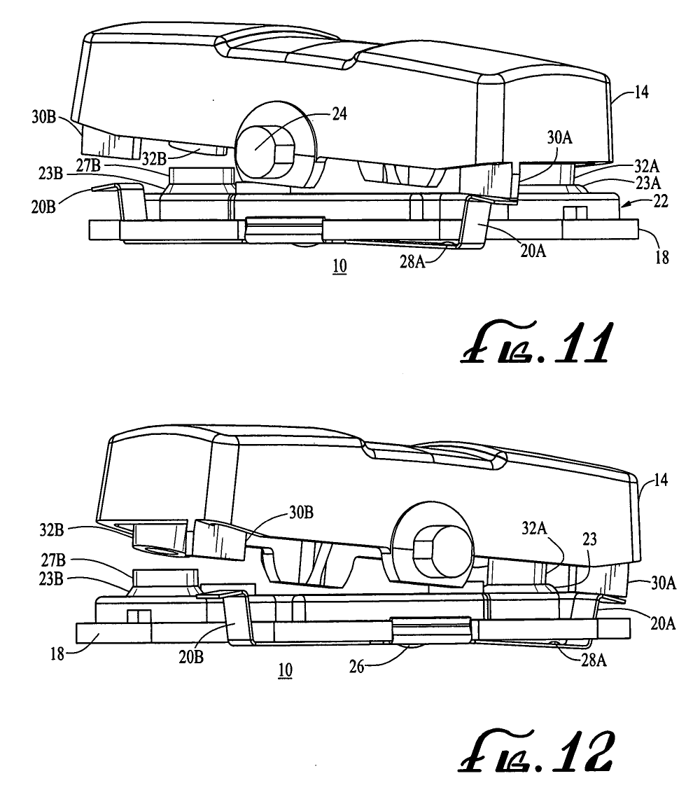

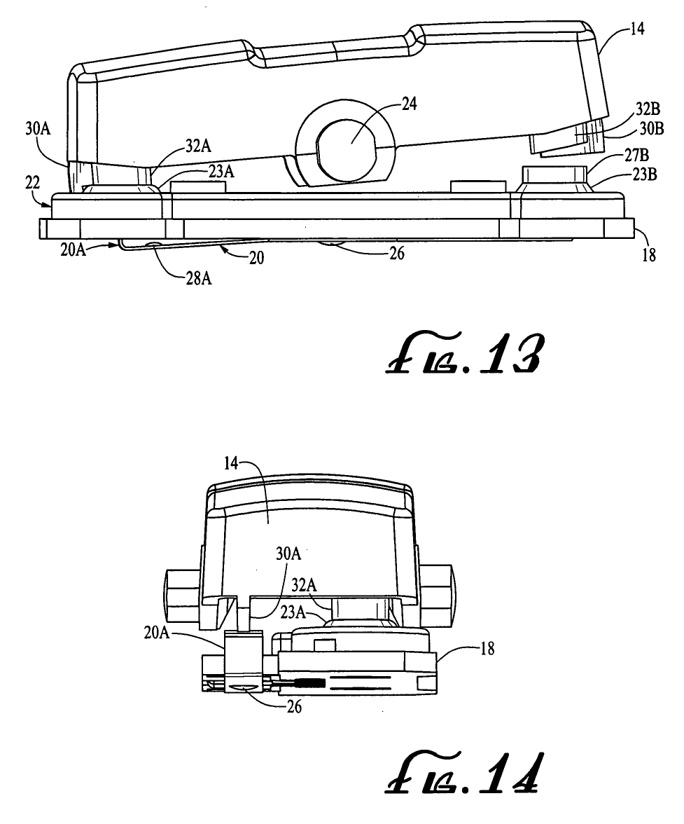

FIGS. 11-14 show that the rocker 14 is fully pivoted to one side. FIGS. 11 and 12 show perspective views of the switch 10 with the rocker 14 fully pivoted to one side. FIG. 13 shows a side view of the switch 10 with the rocker 14 fully pivoted to one side. FIG. 14 shows an end view of the switch 10 with the rocker 14 fully pivoted to one side. When the rocker 14 is fully pivoted, the rocker protrusion 32A further pushes the top 27A, compressing it essentially completely into the corresponding dome 23A of the keypad 22, such that the compressed top 27A is no longer visible in FIGS. 11-14. The uncompressed top 27B remains visible however. Further, the protrusion 28A of the contact 20 is further pushed away (separated) from the bottom surface of the PCB 18.

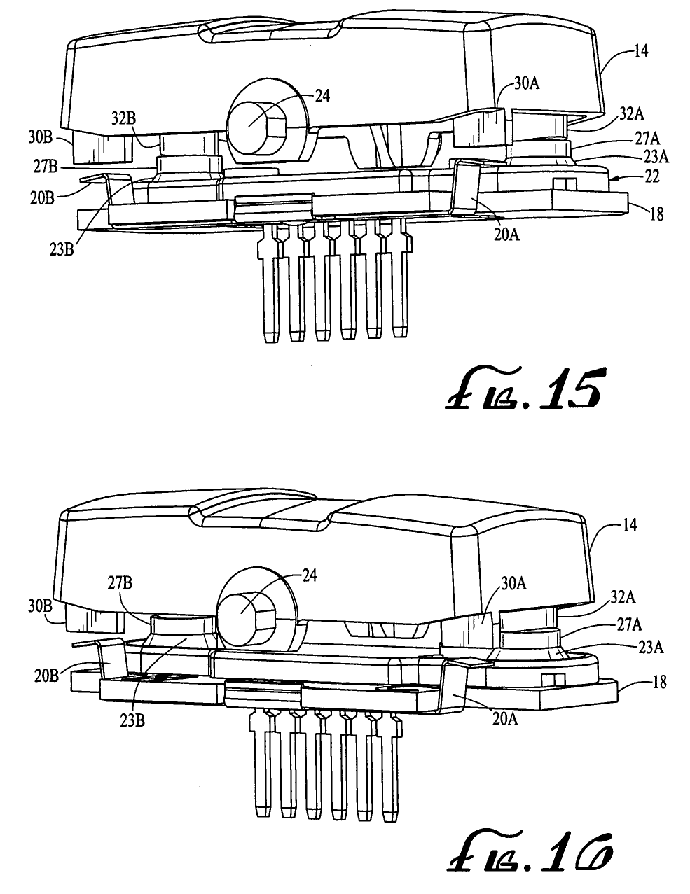

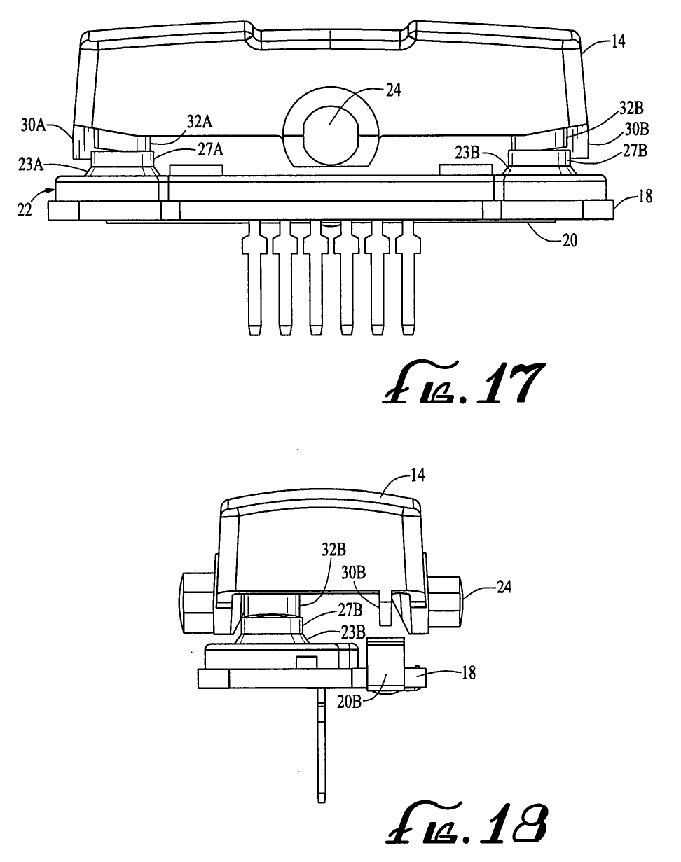

FIGS. 15-18 show the rocker 14 returned from the fully pivoted position shown in FIGS. 11-14, back to the normal position where the rocker 14 is not pivoted to either side (as in FIGS. 7-10). Specifically, FIGS. 15 and 16 show perspective views of the switch 10 with the rocker 14 not pivoted. As such neither domes 23A, 23B are uncompressed, and both protrusions 28A, 28B of the contact 20 are again urged against the bottom surface of the PCB 18. FIG. 17 shows a side view of the switch 10 with the rocker 14 not pivoted, and FIG. 18 shows an end view of the switch 10 with the rocker 14 not pivoted.

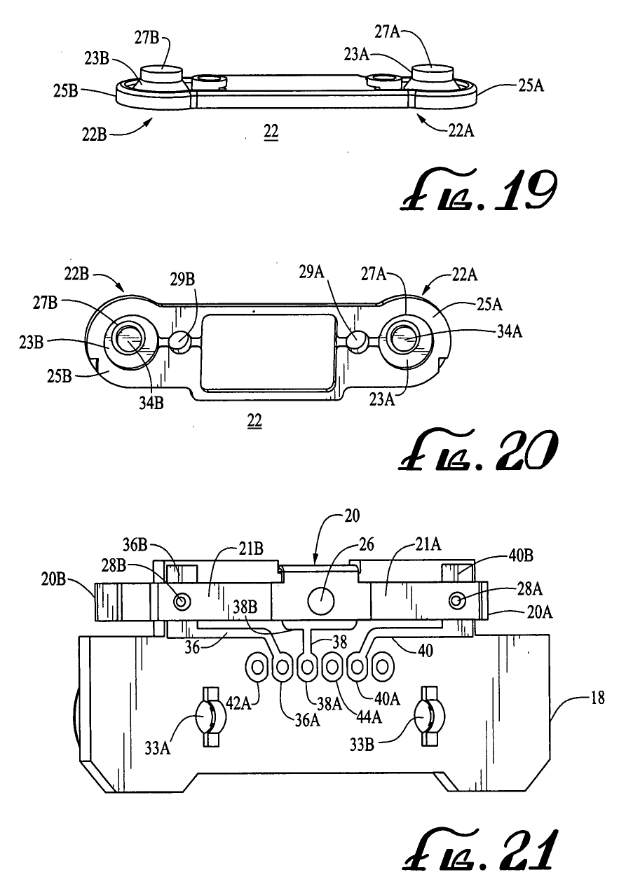

FIG. 19 illustrating a perspective view of the top of the keypad 22 alone, showing a key switch at each end of the keypad 22, wherein a first key switch 22A comprises the retainer 25A, the dome 23A and the top 27A. A second key switch 22B comprises the retainer 25B, the dome 23B and the top 27B. FIG. 20 shows a perspective view of the bottom of the keypad 22, further comprising conductive disks 34A and 34B disposed inside the tops 27A and 27B, respectively.

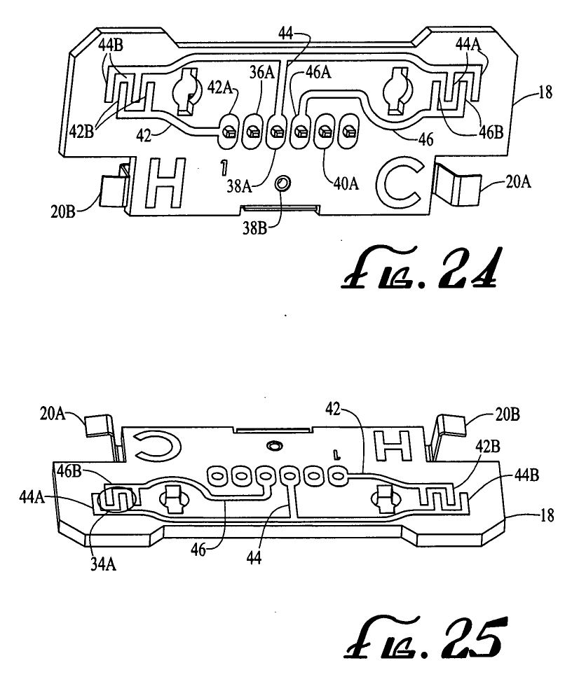

FIG. 21 shows a perspective view of the bottom surface of the PCB 18. Conductive trace 36 runs between nodes 36A, 36B, conductive trace 38 runs between nodes 38A, 38B, and conductive trace 40 runs between nodes 40A, 40B. Further, the center 26 of the contact 20 is connected to the node 38B. FIG. 22 shows another perspective view of the bottom surface of the PCB 18. FIG. 23 shows another perspective view of the PCB 18 wherein a contact pin 36C is connected to node 36A, a contact pin 38C is connected to node 38A and a contact pin 40C is connected to node 40A.

If the rocker 14 is not pivoted (e.g., FIGS. 15-18), the protrusion 28A of the contact 20 is urged against, and electrically coupled to, the node 40B, whereby the nodes 38A and 40A are electrically connected through a portion 21A (contact switch 21A) of the contact 20 between the center 26 and the protrusion 28A (i.e., the contact switch 21A is in a closed switch position). Similarly, if the rocker 14 is not pivoted, then the protrusion 28B of the contact 20 is urged against, and electrically coupled to, the node 36B, whereby the nodes 36A and 38A are electrically connected through a portion 21B (contact switch 21B) of the contact 20 between the center 26 and the protrusion 28B (i.e., the contact switch 21B is in a closed switch position).

When the rocker 14 is partially, or fully, pivoted to the side of the contact switch 21A (e.g., FIGS. 7-10, 11-14), then the rocker protrusion 30A presses against the L-shaped end 20A of the contact 20, such that the protrusion 28A of contact 20 is pushed away, and separated from, the node 40B, opening the contact switch 21A. Similarly, when the rocker 14 is partially, or fully, pivoted to the side of the contact switch 21B, then the rocker protrusion 30B presses against the L-shaped end 20B of the contact 20, such that the protrusion 28B of the contact 20 is pushed away, and separated from, the node 40B, opening the contact switch 21B.

FIG. 24 shows a perspective view of the upper surface of the PCB 18, including traces 42, 44 and 46. Trace 42 runs between nodes 42A and 42B. Trace 44 runs between nodes 44A, 44B and 38A. Trace 46 runs between nodes 46A and 46B. FIG. 8 shows another perspective view of the upper surface of the PCB 18.

The keypad 22 is placed on the upper/top surface of the PCB 18 (FIG. 6) such that the disk 34A (FIGS. 19-20) of the key switch 22A is centered atop the nodes 44A, 46B (FIGS. 24-25) on the top surface of the PCB 18 proximate the L-shaped end 20A of the contact 20. Similarly, the disk 34B (FIGS. 19-20) of the key switch 22B is centered atop the nodes 42B, 44B (FIGS. 24-25) on the top surface of the PCB 18 proximate the L-shaped end 20B of the contact 20.

When the rocker 14 is fully pivoted towards L-shaped end 20A of contact 20 (e.g., FIGS. 11-14), the rocker protrusion 32A pushes the top 27A, compressing it essentially completely into the corresponding dome 23A of the keypad 22, such that the conductive disk 34A under the top 27A is urged against, and electrically coupled to, the nodes 44A and 46B on top surface of the PCB 18 (FIG. 25). When the disk 34A is electrically coupled to the nodes 44A and 46B, the key switch 22A is considered closed, whereby the nodes 38A and 46A are electrically connected. When the rocker 14 is not fully pivoted towards L-shaped end 20A, such that the conductive disk 34A under the top 27A is not electrically coupled to the nodes 44A and 46B, then the key switch 22A is considered open. Since the rocker 14 is normally not pivoted at all, then the key switch 22A is considered normally-open, and is closed only when the rocker 14 is fully pivoted towards L-shaped end 20A of the contact 20.

When the rocker 14 is fully pivoted towards L-shaped end 20B of the contact 20, the rocker protrusion 32B pushes the top 27B, compressing it essentially completely into the corresponding dome 23B of the keypad 22, such that the conductive disk 34B under the top 27B is urged against, and electrically coupled to, the nodes 42B and 44B on the top surface of the PCB 18. When the disk 34A is electrically coupled to the nodes 42B and 44B, the key switch 22B is considered closed, whereby the nodes 38A and 42A are electrically connected. When the rocker 14 is not fully pivoted towards the L-shaped end 20B, such that the conductive disk 34B under the top 27B is not electrically coupled to the nodes 42B, 44B, then the key switch 22B is considered open. Since the rocker 14 is normally not pivoted at all, then the key switch 22B is considered normally-open, and is closed only when the rocker 14 is fully pivoted towards L-shaped end 20B of the contact 20.

Similarly, since the rocker 14 is normally not pivoted at all, then the contact switches 21A and 21B are normally-closed. As such, contact switches 21A, 21B are normally-closed, and key switches 22A, 22B are normally-open. When the rocker 14 is partially pivoted towards the L-shaped end 20A, then the normally-closed contact switch 21A is opened, while the normally-open key switch 22A remains open. When the rocker 14 is fully pivoted towards the L-shaped end 20A, then the contact switch 21A remains open while the key switch 22A is closed. Throughout the pivoting of the rocker 14 toward the L-shaped end 20A, the normally-closed contact switch 21B and normally-open key switch 22B, maintain their states without change.

When the rocker 14 is partially pivoted towards the L-shaped end 20B, then the normally-closed contact switch 21B is opened, while the normally-open key switch 22B remains open. When the rocker 14 is fully pivoted towards the L-shaped end 20B, then the contact switch 21B remains open while the key switch 22B is closed. Throughout the pivoting of the rocker 14 toward the L-shaped end 20B, the normally-closed contact switch 21A and the normally-open key switch 22A, maintain their states without change. The bottom surface of the PCB 18 along with the contact 20 implement the normally-closed contact switches 21A, 21B, whereas the top surface of the PCB 18 along with the keypad 22 implement the normally-open key switches 22A, 22B.

Table A below summarizes the switch state transitions as the rocker 14 is moved from normally not pivoted, to partially pivoted toward the L-shaped end 20A, and then to fully pivoted toward the L-shaped end 20A.

TABLE A
Switching States when Rocker Pivoting towards 20A

| | No pivot | Partial pivot to A | Full pivot to A |
|---|---|---|---|
| Contact Switch 21A | closed | open | open |
| Key Switch 22A | open | open | closed |
| Contact Switch 21B | closed | closed | closed |
| Key Switch 22B | open | open | open |

Table B below summarizes the switch state transitions as the rocker 14 is moved from normally not pivoted, to partially pivoted toward the L-shaped end 20B, and then to fully pivoted toward the L-shaped end 20B.

TABLE B
Switching States when Rocker Pivoting towards 20B

| | No pivot | Partial pivot to B | Full pivot to B |
|---|---|---|---|
| Contact Switch 21A | closed | closed | closed |
| Key Switch 22A | open | open | open |
| Contact Switch 21B | closed | open | open |
| Key Switch 22B | open | open | closed |

Depressing one end of the rocker 14 opens a normally closed contact (21A or 21B). If the rocker 14 is pressed further, a normally open contact in the keypad tops (27A or 27B) is closed while the first (normally open) contact remains open. Since the rocker pivots in the middle and is supported at each end by the spring-like domes of the keypad, when the rocker is released, both switch elements are returned to their original state. Because of this configuration, the switch can function in three ways: (1) as a SPDT normally open momentary switch, (2) as a SPDT normally closed switch, and (3) as a DPDT switch with one set of normally closed and one set of normally open contacts for each pole. In one example application of switch 10 where the switch 10 is connected to control a circuit, when one side of the rocker 14 is depressed, it closes a normally open switch which toggles the circuit to a “ON” state for the function of the corresponding side. Depressing the rocker 14 again (on either side) opens the corresponding normally closed contact and closes the corresponding normally open switch. This last sequence has no effect on the circuit, however when the rocker 14 is released, the normally open switch breaks contact and the normally closed contact re-makes contact. This has the effect of resetting the circuit to the OFF/neutral position awaiting the next input. If either side of the rocker is depressed (and released), that function will turn ON until it is turned OFF and the circuit is reset by the previously described sequence.

One example application of the dual mode switch 10 is as a toggle switch to either control a circuit in two states (high or low; hot (H) or cold (C), etc.) plus off, or one of two devices (each on-off) plus all off. When used with a flip-flop circuit, the normally closed contacts can be used to reset the circuit, while the normally open contacts can be used to trigger a control circuit to toggle the device on or off. For example, in a heat/cool application, pressing one side of the rocker 14 would turn on the heat function. Pressing either side of the rocker 14 after the heating (or cooling) is on would then turn it off. Pressing the heating side (or cooling side) once more would turn that function on again, etc.

In another example, by depressing one side of the rocker 14, partially pivoting the rocker 14 onto the keypad top 27A of normally-open switch 22A, the normally-closed switch 21A is opened, while the normally-open switch 22A remains open. During the period of time when the rocker 14 is partially pivoted (from being not pivoted to being fully pivoted), both switches 21A and 22A are open. By further depressing the rocker 14, fully pivoting the rocker 14 onto the keypad top 27A of normally-open switch 22A, the normally-closed switch 21A remains open and the normally-open switch 22A is closed.

In a reverse action, by depressing the rocker 14 to fully pivot the rocker 14 onto the keypad top 27B of normally-open switch 22B, the normally-closed switch 21B is opened, and the normally-open switch 22B is closed. During the period of time when the rocker 14 is partially pivoted (from being not pivoted to being fully pivoted), both switches 21B and 22B are open.

Once pressure on the rocker 14 is released, the decompressing action of the keypad 22, pushes the rocker 14 back to the un-pivoted state (e.g., FIGS. 15-18), whereby the switch 10 has a self-centering neutral or a middle/neutral state. When the rocker 14 is partially pivoted towards the L-shaped end 20A, then the normally-closed switch 21A is opened. Then, when the rocker 14 is fully pivoted towards the L-shaped end 20A, the normally-open switch 22A is closed. Then, when pressure on the rocker 14 is released, the rocker 14 returns to self-centered position whereby switch 22A is opened again and switch 21A is closed again. In a reverse action, when the rocker 14 is partially pivoted towards L-shaped end 20B, then normally-closed switch 21B is opened. Then when the rocker 14 is fully pivoted towards the L-shaped end 20B, normally-open switch 22B is closed. Then, when pressure on the rocker 14 is released, the rocker 14 returns to self-centered position whereby switch 22B is opened again and switch 21B is closed again.

The contact 20 and/or the keypad 22 are preloaded and their tolerances selected to provide clearances that present the switch 10 from rattling due to vibration. Preferably, the rocker 14 is normally sprung up (supported) to the un-pivoted (centered) position by the keypad 22 and/or the contact 20, keeping the rocker 14 from pivoting, so that in the un-pivoted position the rocker 14 feels rattle free to user touch. As such, the keypad 22 and/or the contact 20 offers resistance against pivoting of the rocker 14, and the amount of resistance to pivoting can be selected by selecting the physical characteristics of the contact 20, and the keypad 22. The physical characteristics can include height, width, thickness, material, elasticity, etc. The domes 23A and 23B are elastic springy semi-rigid and normally uncompressed, and when the rocker 14 is in its centered (un-pivoted) position there is some freeloader effect and domes 23A, 23B are very slightly compressed (without closing the normally-open contacts), to keep the rocker 14 stabilized over the keypad 22. The domes 23A, 23B push up against the rocker keeping the rocker 14 from pivoting.

In another example, the protrusions 30A, 30B of the rocker 14 can be supported, and sprung up, by the L-shaped ends 20A, 20B, respectively, of the contact 20. The rocker protrusions 30A, 30B may rest on L-shaped ends 20A, 20B, respectively of the springy contact 20, wherein the L-shaped ends 20A, 20B push up against the rocker protrusions 30A, 30B, keeping the rocker 14 from pivoting.

In another example, the protrusions 32A, 32B of the rocker 14 can be supported, and sprung up, by the tops 27A, 27B, respectively, of the keypad 22. This is shown in FIGS. 15-18, wherein the protrusions 32A, 32B, normally rest on the semi-rigid tops 27A, 27B, respectively, without play, and with the tops 27A, 28B sprung up against the protrusions 32A, 32B, respectively, so that in the un-pivoted (centered) position the rocker 14 feels rattle free to user touch. The domes 23A, 23B are elastic/springy/semi-rigid and are normally uncompressed in the sense that the normally open contacts remain open (FIGS. 19, 20, 6), wherein the domes 23A, 23B push the tops 27A, 27B against the rocker protrusions 32A, 32B, respectively, keeping the rocker 14 from pivoting to either side.

Yet in another example, a combination of the above two examples can be utilized, wherein the protrusions 32A, 32B of the rocker 14 are supported, and sprung up, by the tops 27A, 27B, respectively, of the keypad 22, and the protrusions 30A, 30B of the rocker 14 are supported, and sprung up, by the L-shaped ends 20A, 20B, respectively, of the contact 20.

While the present invention is susceptible of embodiments in many different forms, there are shown in the drawings and herein described in detail, preferred embodiments of the invention with the understanding that this description is to be considered as an exemplification of the principles of the invention and is not intended to limit the broad aspects of the invention to the embodiments illustrated. The present invention has been described in considerable detail with reference to certain preferred versions thereof; however, other versions are possible. Therefore, the spirit and scope of the appended claims should not be limited to the description of the preferred versions contained herein.

What is claimed is:

1. A switching apparatus, comprising:
a normally-open switching device comprising first and second normally-open switches;
a normally-closed switching device comprising first and second normally-closed switches; and
an actuator operable in conjunction with the switching devices such that: (a) in a neutral actuator mode the first and second normally-open switches remain open, and the first and second normally-closed switches remain closed, (b) in a first operation mode the actuator operates on the first normally-closed switch and the first normally-open switch, and (c) in a second operation mode the actuator operates on the second normally-closed switch and the second normally-open switch.

2. The apparatus of claim 1, wherein in the first mode from the neutral mode, in a first state the actuator transitions the switching devices such that the first normally-closed switch is open and the first normally-open switch is open.

3. The apparatus of claim 2, wherein in the first mode, in a second state following the first state, the actuator further transitions the switching devices such that the first normally-closed switch is open and the first normally-open switch is closed.

4. The apparatus of claim 3, wherein in the first mode, returning back to the first state from the second state, the actuator further transitions the switching devices such that the first normally-closed switch is open and the first normally-open switch is open.

5. The apparatus of claim 4, wherein in returning back to the neutral mode from the first mode, the actuator further transitions the switching devices such that the first normally-closed switch is closed and the first normally-open switch is open.

6. The apparatus of claim 1, wherein in the second mode from the neutral mode, in a first state the actuator transitions the switching devices such that second normally-closed switch is open and the second normally-open switch is open.

7. The apparatus of claim 6, wherein in the second mode, in a second state following the first state, the actuator further transitions the switching devices such that the second normally-closed switch is open and the second normally-open switch is closed.

8. The apparatus of claim 7, wherein in the second mode, returning back to the first state from the second state, the actuator further transitions the switching devices such that the second normally-closed switch is open and the second normally-open switch is open.

9. The apparatus of claim 8, wherein in returning back to the neutral mode from the second mode, the actuator further transitions the switching devices such that the second normally-closed switch is closed and the second normally-open switch is open.

10. A switching apparatus, comprising:
a circuit board including electrically conductive nodes;
a contact strip adjacent the circuit board, the contact strip comprising: a first electrically conductive contact element proximate two corresponding nodes on the circuit board, and a second electrically conductive contact element proximate two corresponding nodes on the circuit board, wherein the first contact element is normally electrically coupled to said corresponding nodes, forming a first normally-closed switch, and the second contact element is normally electrically coupled to said corresponding nodes, forming a second normally-closed switch;
a keypad adjacent the circuit board, the keypad comprising: a first electrically conductive contact member proximate two corresponding nodes on the circuit board, and a second electrically conductive contact member proximate two corresponding nodes on the circuit board, wherein the first contact member not normally electrically coupled to said corresponding nodes, forming a first normally-open switch, and the second contact member is not normally electrically coupled to said corresponding nodes, forming a second normally-open switch; and
a rocker operable in conjunction with the contact strip and the keypad such that: (a) in a neutral rocker mode the normally-open switches remain open, and the normally-closed switches remain closed, (b) in a first operation mode the rocker operates on the first contact element and the first contact member, and (c) in a second operation mode the rocker operates on the second contact element and the second contact member.

11. The apparatus of claim 10, wherein in the first mode from the neutral mode, in a first state the rocker urges the first contact element away from the circuit board, breaking electrical coupling between the first contact element and said corresponding nodes, to open the first normally-closed switch, while the first normally-open switch remains open.

12. The apparatus of claim 11, wherein in the first mode, in a second state following the first state, the rocker urges the first contact member against said corresponding node, wherein the first contact member makes electrical coupling to said corresponding nodes, to close the first normally-open switch, while the first normally-closed switch remains open.

13. The apparatus of claim 12, wherein in the first mode, returning back to the first state from the second state, the rocker further accommodates the first contact member away from the corresponding nodes, breaking electrical coupling between the first contact member and said corresponding nodes, to open the first normally-open switch, while the first normally-closed switch remains open.

14. The apparatus of claim 13, wherein in returning back to the neutral mode from the first mode, the rocker further accommodates the first contact element to urge against the corresponding nodes, wherein the first contact element makes electrical coupling to said corresponding nodes, to close the normally-closed switch, while the first normally-open switch remains open.

15. The apparatus of claim 14, wherein in the second mode from the neutral mode, in a first state the rocker urges the second contact element away from the circuit board, breaking electrical coupling between the second contact element and said corresponding nodes, to open the second normally-closed switch, while the second normally-open switch remains open.

16. The apparatus of claim 15, wherein in the second mode, in a second state following the first state, the rocker urges the second contact member against said corresponding node, wherein the second contact member makes electrical coupling to said corresponding nodes, to close the second normally-open switch, while the second normally-closed switch remains open.

17. The apparatus of claim 16, wherein in the second mode, returning back to the first state from the second state, the rocker further accommodates the second contact member away from the corresponding nodes, breaking electrical coupling between the second contact member and said corresponding nodes, to open the second normally-open switch, while the second normally-closed switch remains open.

18. The apparatus of claim 17, wherein in returning back to the neutral mode from the second mode, the rocker further accommodates the second contact element to urge against the corresponding nodes, wherein the second contact element makes electrical coupling to said corresponding nodes, to close the normally-closed switch, while the second normally-open switch remains open.

19. The apparatus of claim 18 wherein in the first mode the rocker pivots onto the first normally-closed switch and first normally-open switch.

20. The apparatus of claim 19 wherein in the second mode the rocker pivots onto the second normally-closed switch and second normally-open switch.

21. The apparatus of claim 20 wherein the circuit board has opposing surfaces, wherein the keypad and the contact strip are adjacent said opposing surfaces with the circuit board essentially sandwiched between the keypad and the contact strip.

22. The apparatus of claim 21 wherein the keypad further includes:
a first flexible, semi-rigid, non-conductive dome that supports said first contact member proximate the circuit board, wherein when the rocker is pressed to pivot onto the first dome, in the second state of the first mode, the first dome is compressed such that the first contact member makes electrical coupling with said corresponding nodes; and
a second flexible, semi-rigid, non-conductive dome that supports said second contact member proximate the circuit board, wherein when the rocker is pressed to pivot onto the second dome, in the second state of the second mode, the second dome is compressed such that the second contact member makes electrical coupling with said corresponding nodes.

23. The apparatus of claim 22 wherein the domes are spring loaded, and the rocker is adjacent the domes such that the domes urge against, and maintain, the rocker in the neutral mode.

24. The apparatus of claim 22 wherein the keypad is elongated with the domes located at distal ends of the keypad.

25. The apparatus of claim 24 wherein the contact strip is elongated, having first and second distal ends, wherein when the rocker is pressed to pivot onto the first distal end of the contact strip, the first distal end including said first contact element and the second distal end including said second contact element;
wherein in the first state of the first mode, the first distal end of the contact strip is urged away from the circuit board such that the first contact element breaks electrical coupling with said corresponding nodes, and in the first state of the second mode, the second distal end of the contact strip is urged away from the circuit board such that the second contact element breaks electrical coupling with said corresponding nodes.

26. The apparatus of claim 23 wherein the contact strip is connected to the circuit board around the center of the contact strip.

27. The apparatus of claim 24 wherein the contact strip is conductive.

28. The apparatus of claim 24 wherein:
the first distal end of the keypad and the first distal end of the contact strip are proximate and situated on opposing surfaces of the circuit board; and
the second distal end of the keypad and the second distal end of the contact strip are proximate and situated on opposing surfaces of the circuit board.
